(19) United States
(12) Patent Application Publication
(10) Pub. No.: US 2025/0332057 A1
(43) Pub. Date: Oct. 30, 2025

(54) AUXILIARY EXERCISE DEVICE BASED ON SPORTS KINESIOLOGY

(71) Applicant: Shandong Normal University, Jinan (CN)

(72) Inventors: Wen Jing, Jinan (CN); Qi Chen, Jinan (CN); Chuanfen Li, Jinan (CN)

(21) Appl. No.: 18/675,162

(22) Filed: May 28, 2024

(30) Foreign Application Priority Data
Apr. 28, 2024 (CN) 202410520887.0

(51) Int. Cl. A61H 7/00; A63B 21/00; A63B 21/062; A63B 71/04

(52) U.S. Cl. CPC A61H 7/003; A63B 21/063; A63B 21/154; A63B 21/4034; A63B 71/04; A61H 2201/0149; A61H 2201/1261; A61H 2201/149

(57) ABSTRACT

An auxiliary exercise device based on sports kinesiology includes: an exercise box, multiple weights, an adjusting sleeve, multiple groups of positioning rods, two guide blocks, two guide board, an up-and-down moving assembly, a first resilient rest assembly and a foot pedal assembly. The two guide blocks are located at two sides of the adjusting sleeve and close to the multiple groups of positioning rods and two opposite surfaces of the two guide blocks are inclined surface and in a splayed shape. The up-and-down moving assembly is connected with the two guide blocks and configured to drive the two guide blocks to move upwards and downwards. The foot pedal assembly is configured to provide power for the up-and-down moving assembly. The device makes it simple for an exerciser to adjust the number of weights without leaving an exercise position, thereby meeting the progressivity principle of sports kinesiology.

### TECHNICAL FIELD

The disclosure relates to the field of sports equipment technologies, and particularly to an auxiliary exercise device based on sports kinesiology.

### BACKGROUND

Sports kinesiology, also known as human movement science or sports biology, is a discipline group that studies the relationship and laws between sports and the human body. Sports kinesiology can guide exercisers to exercise scientifically and effectively under the basic principles, which mainly includes the principle of comprehensiveness, the principle of regularity, the principle of progressivity, the principle of individuality, and the principle of conscientiousness. The principle of comprehensiveness points out that exercise should consider the influence on the whole body and avoid excessive singular exercises. The principle of progressivity points out that everyone should exercise according to their actual situation, and the principle of progressivity suggests everyone exercise from easy to difficult and progressively increase the exercise load from small to large. If they violate the principle of progressivity and rush to achieve results, they will not only fail to effectively strengthen their physical fitness, but may also damage their health.

At present, exercisers often use auxiliary exercise devices when taking upper limb strength exercise. The auxiliary exercise devices include multiple weights set sequentially from top to bottom, and the number of weights is adjusted by inserting positioning pins into the weights at different positions to adjust the size of the exercise load. Then the exerciser pulls the cross bar with two hands to drive the weights up and down to take upper limb strength exercise.

However, in order to meet the principle of progressivity of sports kinesiology, the adjustment of the exercise load needs to be gradually increased from small to large. It is relatively inconvenient to adjust the weights of the existing exercise device as exercisers need to interrupt the exercise for multiple times to adjust the weights one by one, making it difficult to meet the requirements of the scientific exercise. If exercisers need to continue exercising without interruption, specialized auxiliary personnel are further needed to cooperate.

### SUMMARY

The purpose of the present disclosure is to provide an auxiliary exercise device based on spots kinesiology, which is able to meet the principle of progressively of sports kinesiology and make it easy to adjust the number of the weights for the exerciser without leaving the exercise position.

In order to achieve above purposes, specific technical solutions of the present disclosure are as follows.

An auxiliary exercise device based on sports kinesiology includes:
an exercise box;
multiple weights, located in the exercise box vertically;
an adjusting sleeve, sleeved on the multiple weights; where two sides of each weight defines positioning holes respectively;
multiple groups of positioning rods, corresponding to the multiple weights respectively; where each group of positioning rods has two positioning rods, the two positioning rods are horizontally located at two sides of the corresponding weight, an end of each positioning rod passes through an inner wall of the adjusting sleeve and is connected to a first resilient reset assembly, and another end of each positioning rod is close to a corresponding one of the two positioning holes of the respective weight;
two guide blocks, located at two sides of the adjusting sleeve respectively and close to the multiple groups of positioning rods; where two opposite surfaces of the two guide blocks are inclined surfaces and are in a splayed shape;
two guide boards, vertically located on upper parts of the two guide blocks respectively;
an up-and-down moving assembly, located inside the exercise box and connected to the two guide blocks; where the up-and-down moving assembly is configured to drive the two guide blocks to move downward, thereby to make the inclined surfaces of the two guide blocks sequentially drive the multiple group of positioning rods to be inserted into the positioning holes of the multiple weights, or drive the two guide blocks to move upward, thereby to make the inclined surfaces of the two guide blocks sequentially drive the multiple group of positioning rods to be withdrawn from the positioning holes of the multiple weights; and
a foot pedal assembly, located outside the exercise box and configured to provide power for the up-and-down moving assembly.

The present disclosure further includes the following contents.

The up-and-down moving assembly includes: two lead screws vertically located at two sides of the adjusting sleeve respectively and closed to the two guide blocks respectively. Each lead screw passes through the respective guide block and is threadedly connected to the respective guide block. Two ends of each lead screw are rotatably connected to inner walls of the exercise box respectively. A side of each guide block facing away from the adjusting sleeve is slidably connected to an inner wall of the exercise box in a vertical direction, and the two lead screws are connected to a first transmission assembly.

The first transmission assembly includes: a base, a first rotation shaft, a first spur gear, two second spur gear, an adjusting box and a worm. The base is located on a bottom of the exercise box and the base has a hollow structure. A lower end of each lead screw passes through the exercise box and an upper part of the base and is rotatably connected with a lower part of the base. The first rotation shaft is vertically located between the two lead screws and the first spur gear is sleeved on the first rotation shaft. The two second spur gear are respectively sleeved on the two lead screws, and the first spur gear is meshed with each of the two second spur gears. The adjusting box is located on the base and connected to the base. The worm is horizontally located inside the adjusting box and two ends of the worm pass through the adjusting box and connect with the foot pedal assembly. The foot pedal assembly is configured to drive the worm to rotate, and a second transmission assembly is provided between the worm and the first rotation shaft.

The second transmission assembly includes: a second rotation shaft, a worm wheel, a first bevel gear and a second bevel gear. The second rotation shaft is horizontally located under the worm and perpendicular to the worm. The worm wheel is sleeved on the second rotation shaft. The worm is meshed with the worm wheel. The first bevel gear is sleeved near the second rotation shaft on the first rotation shaft, and the second bevel gear is sleeved near the first bevel gear on the second rotation shaft. The second bevel gear is meshed with the first bevel gear.

A sitting board is horizontally located between the adjusting box and the exercise box. A back board is vertically located on a side close to the exercise box of the sitting board, and the back board has a hollow structure. A massage board is vertically arranged in the back board, and an edge of the massage board is connected to an inner wall of the back board by a second resilient reset assembly. A side close to the adjusting box of the back board defines multiple massage grooves vertically and evenly, and a massage rod is horizontally located in each massage groove. An end of each massage rod is connected to the massage board. A first massage assembly is located between the massage board and the first spur gear, and the first massage assembly is configured to drive the massage board to move up and down through the rotation of the first spur gear.

The first massage assembly includes: a massage box, a carrier rod, a first roller, multiple first hemispherical protrusions and a moving rod. The massage box is vertically located between the back board and the exercise box. The carrier rod is vertically located in the massage box and a lower part of the carrier rod passes through the massage box and an upper part of the base and is located in the base. The first roller is located on the lower part of the carrier rod, and the first roller is in contact with an upper surface of the first spur gear. The multiple first hemispherical protrusions are located on the upper surface of the first spur gear and evenly arranged around the first rotation shaft. The multiple first hemispherical protrusions are sequentially in contact with the first roller during the rotation of the first spur gear. A third resilient reset assembly is provided between the carrier rod and the massage box. The moving rod is horizontally located at an upper part of the carrier rod. Two sides of the massage box near the two ends of the moving rod respectively define two first sliding grooves vertically, and the back board defines a second sliding groove vertically near the first sliding grooves. An end of the moving rod passes through one of the first sliding grooves and the second sliding groove and is connected with the massage board.

A sleeve is sleeved on the moving rod and two ends of the sleeve are respectively located in the two first sliding grooves. The upper part of the carrier rod is connected to the sleeve. The exercise box defines a third sliding groove vertically near the other first sliding groove, and a slider is located inside the third sliding groove. The other end of the moving rod passes through the other first sliding groove and is connected with the slider. A second massage assembly is located between the slider and the adjusting sleeve, and the second massage assembly is configured to drive the massage board to move horizontally back and forth by the moving rod.

The second massage assembly includes: multiple second hemispherical protrusions located on a side close to the slider of the adjusting sleeve. The multiple second hemispherical protrusions are located under the slider and arranged evenly and vertically. A side near the adjusting sleeve of the slider defines a ball groove and a movement ball is located in the ball groove. A side of the movement ball is close to the adjusting sleeve. A traction assembly is provided above the sitting board and the traction assembly is connected to the adjusting sleeve.

The traction assembly includes: a roof panel, a cross bar and a drawstring. The roof panel is horizontally located on the exercise box, an upper part of the exercise box is connected to a rear part of the roof panel. Two sides of a lower part of the roof panel near a front part of the roof panel is connected with the base through vertically arranged support columns respectively. The roof panel has hollow structure inside. An upper end of each guide board passes through the exercise box and the roof panel, and is slidably connected with the exercise box and the roof panel. The cross bar is horizontally located between the sitting board and the roof panel. The drawstring is located in the roof panel, and two ends of the drawstring are respectively connected to the cross bar and the adjusting sleeve.

The foot pedal assembly includes: two foot pedals, and the two foot pedals are horizontally located on two sides of the adjusting box. The two foot pedals are located above and below the worm respectively, and each foot pedal is rotatably connected with the worm by a vertically disposed connecting rod.

The auxiliary exercise device based on sports kinesiology provided by the present disclosure can meet the principle of progressivity of sports kinesiology, and it allows the exerciser to easily adjust the number of the weights progressively without leaving the exercise position for multiple times, meeting the scientific nature of exercise as much as possible. The present disclosure has following advantages.

Firstly, each group of positioning rods can be driven to horizontally be inserted into corresponding positioning holes or be withdrawn from the corresponding positioning holes through the coordination of the multiple weights, the adjusting sleeve, the multiple groups of positioning rods, the two guide blocks, the two guide boards, the up-and-down moving assembly and the foot pedal assembly. It meets the principle of progressivity of sports kinesiology and allows the exerciser to easily adjust the number of the weights progressively without stopping exercising and leaving the exercise position for multiple times, thereby improving the effect of the exercise.

Secondly, exercisers can engage in cycling while adjusting their exercise load through the coordination of the first transmission assembly, the second transmission assembly and the foot pedal assembly, allowing them to warm up with aerobic exercise before anaerobic exercise. By this, exercisers can avoid singular strength exercises and ensure that muscles are in a relatively relaxed state during upper limb strength exercises, avoiding damage to the body during the exercise. The exercise is more in line with the basic principles of sports kinesiology.

Thirdly, exercisers are able to perform back massage while adjusting exercise load to promote blood circulation in their backs through the coordination of the back board, the massage board, the multiple massage rods and the first massage assembly. Exercisers' muscles get relaxed during the exercise, further making the exercise more in line with the basic principles of sports kinesiology.

Fourthly, exercisers can perform tapping massage on the back during upper limb strength exercises through the coordination of the back board, the massage board, multiple massage rods, the moving rod, the sleeve and the second massage assembly. This further promote blood circulation in exercisers' backs, making the muscles of exercisers get relaxed during the exercise and the exercise is more in line with the basic principles of sports kinesiology.

### BRIEF DESCRIPTION OF DRAWINGS

FIG. 1 illustrates a schematic structural diagram of an auxiliary exercise device based on sports kinesiology according to an embodiment of the present disclosure.

FIG. 2 illustrates a schematic top view of the auxiliary exercise device based on sports kinesiology according to the embodiment of the present disclosure.

FIG. 3 illustrates a schematic rear view of the auxiliary exercise device based on sports kinesiology according to the embodiment of the present disclosure.

FIG. 4 illustrates a schematic side view of the auxiliary exercise device based on sports kinesiology according to the embodiment of the present disclosure.

FIG. 5 illustrates a schematic top view of an interior of a base of the auxiliary exercise device based on sports kinesiology according to the embodiment of the present disclosure.

FIG. 6 illustrates a schematic enlarged view of the part A in FIG. 4.

FIG. 7 illustrates a schematic enlarged view the part B in FIG. 1.

FIG. 8 illustrates a schematic enlarged view the part C in FIG. 1.

FIG. 9 illustrates a schematic enlarged view the part D in FIG. 2.

FIG. 10 illustrates a schematic enlarged view the part E in FIG. 3.

Description of reference numerals: 1: base; 2: exercise box; 3: roof panel; 4: sitting board; 5: back board; 6: electric telescopic rod; 7: drawstring; 8: cross bar; 9: adjusting box; 10: support column; 11: lead screw; 12: weight; 13: adjusting sleeve; 14: guide block; 15: limited groove; 16: limited block; 17: guide board; 18: positioning rod; 19: positioning hole; 20: first roller; 21: first elastic member; 22: second elastic member; 23: third elastic member; 24: fixed pulley; 25: first rotation shaft; 26: first spur gear; 27: second spur gear; 28: first bevel gear; 29: second bevel gear; 30: worm; 31: worm wheel; 32: second rotation shaft; 33: second roller; 34: fourth elastic member; 35: first hemispherical protrusion; 36: second hemispherical protrusion; 37: massage box; 38: massage board; 39: carrier rod; 40: moving block; 41: sleeve; 42: moving rod; 43: massage groove; 44: massage rod; 45: first sliding groove; 46: second sliding groove; 47: third sliding groove; 48: slider; 49: ball groove; 50: movement ball; 51: connecting rod; 52: foot pedal.

### DETAILED DESCRIPTION OF EMBODIMENTS

Technical solutions of the present disclosure will be clearly described in detail in conjunction with drawings of embodiments.

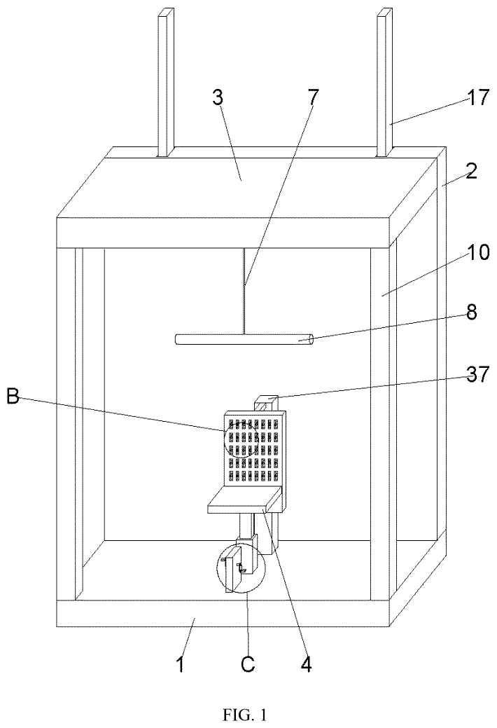

As illustrated in FIGS. 1, 2 and 3, an embodiment of the present disclosure provides an auxiliary exercise device based on sports kinesiology, including: an exercise box 2, an adjusting sleeve 13, multiple weights 12, multiple groups of positioning rods 18, two guide blocks 14 and two guide boards 17. The multiple weights 12 are vertically located in the exercise box 2. The adjusting sleeve 13 is sleeved on the multiple weights 12 and is a box structure with an opening at a bottom. The two sides of each weight 12 define two positioning holes 19 respectively. The multiple groups of positioning rods 18 are located inside the adjusting sleeve 13, and the multiple groups of positioning rods 18 correspond to multiple weights 12 respectively. Each group of positioning rods 18 has two positioning rods 18. Two positioning rods 18 of each group of positioning rods 18 are located horizontally on two sides of the respective weight 12. An end of each positioning rod 18 passes through an inner wall of the adjusting sleeve 13 and is connected with a first resilient reset assembly. The first resilient reset assembly facilitate the reset of the positioning rod 18 after moving horizontally. Another end of each positioning rod 18 is close to one of the two positioning holes and defines a space from the corresponding positioning hole 19. By this, the positioning rods 18 are able to be inserted into the corresponding positioning holes 19 after moving towards the inner wall of the adjusting sleeve 13 by a force, thereby adjusting the number of the weights 12 to adjust the amount of exercise load. The two guide blocks 14 are located at two sides of the adjusting sleeve 13 respectively and the two guide blocks 14 are close to the multiple of groups of positioning rods 18, and the two guide blocks 14 are close to the top of the adjusting sleeve 13. Two opposite surfaces of the two guide blocks 14 are inclined surfaces and are in a splayed shape. In the initial state, the two guide blocks 14 are located above the multiple groups of positioning rods 18, and the inclined surfaces of the two guide blocks 14 are close to the uppermost two positioning rods 18 respectively. During the downward movement of the two guide blocks 14, the inclined surfaces of the two guide blocks contact with the other end of each of the multiple positioning rods 18 to squeeze each positioning rod 18, thereby driving the multiple positioning rods 18 to move horizontally towards the interior of the adjusting sleeve 13 and further to be inserted into the corresponding positioning holes 19. The two guide boards 17 are respectively located on the upper parts of the two guide blocks 14, and the lower ends of the two guide boards 17 are connected to the two guide blocks 14 respectively. The guide boards 17 are flush with positions of the inclined surfaces of the respective guide blocks 14 close to the adjusting sleeve 13, so that each positioning rod 18 is in contact with the side surface of the respective guide board 17 after passing through the inclined surface of the respective guide block 14, thereby ensuring the other end of each positioning rod 18 is consistently inserted in the corresponding positioning hole 19. An up-and-down moving assembly is located in the exercise box 2 and is connected with the two guide blocks 14. The up-and-down moving assembly is configured to drive the two guide blocks 14 to move downwards and upwards, thereby to make the two inclined surfaces of the two guide blocks 14 move downward to sequentially drive each group of positioning rods 18 to move horizontally to be inserted to corresponding positioning holes 19, or move upward to sequentially drive each group of positioning rods 18 to move horizontally to withdraw from the corresponding positioning holes 19 under the action of the first resilient reset assemblies. In this way, the size of exercise load can only be adjusted from small to large or from large to small. A foot pedal assembly is provided outside the exercise box 2, and the foot pedal assembly is configured to provide power for the up-and-down moving assembly.

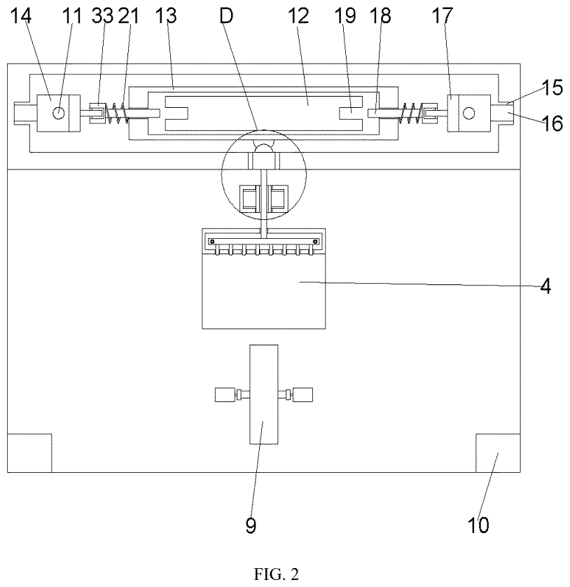

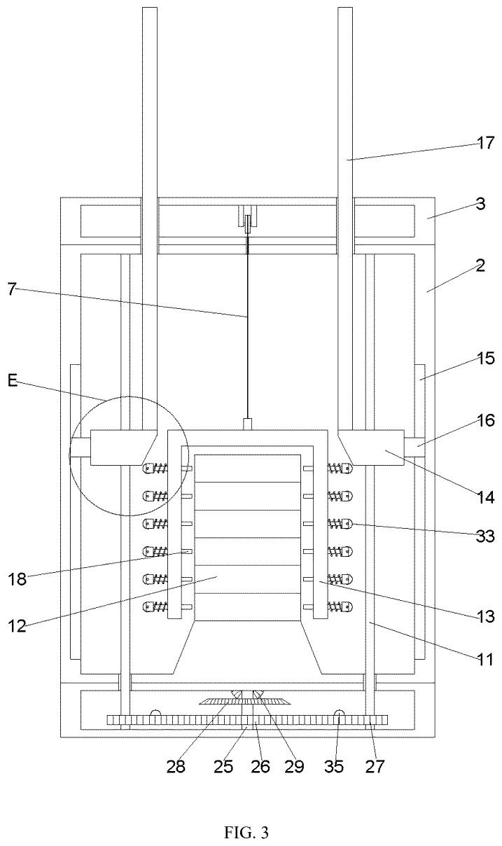

As illustrated in FIGS. 2 and 3, the up-and-down moving assembly includes two lead screws 11 vertically arranged on two sides of the adjusting sleeve 13 respectively and closed to the two guide blocks 14 respectively. Each lead screw 11 passes through the respective guide block 14 and is threadedly connected to the respective guide block 14. Two ends of each lead screw 11 are rotatably connected to inner walls of the exercise box 2 respectively. A side of each guide block 14 facing away from the adjusting sleeve 13 is slidably connected to an inner wall of the exercise box 2 in a vertical direction, limiting the circumferential motion of the guide blocks 14 and making the guide blocks 14 only move upwards or downwards. The two lead screws 11 are connected to a first transmission assembly, which is configured to drive the two lead screws 11 to rotate, thereby to drive the two guide blocks 14 to move upwards and downwards.

As illustrated in FIG. 3, the inner walls of the exercise box 2 define limited grooves 15 near the two guide block 14, respectively. Limited blocks 16 are located inside the limited groove 15, respectively. Each limited block 16 moves freely up and down along the respective limited groove 15, and a side of each limited block 16 is connected with the respective guide block 14.

As illustrated in FIGS. 3, 4, and 5, the first transmission assembly includes: a base 1, a first rotation shaft 25, a first spur gear 26, two second spur gears 27, an adjusting box 9 and a worm 30. The base 1 is located on a bottom of the exercise box 2 and the base 1 has a hollow structure. A lower end of each lead screw 11 passes through the exercise box 2 and an upper part of the base 1 and is rotatably connected with the lower part of the base 1. The first rotation shaft 25 is vertically arranged between the two lead screws 11 and two ends of the first rotation shaft 25 are respectively rotatably connected with inner walls of the base 1 for the rotating of the first spur gear 26. The first spur gear 26 is sleeved on the first rotation shaft 25. The two second spur gears 27 are respectively sleeved on the two lead screws 11, and the first spur gear 26 is meshed with each second spur gear 27. The adjusting box 9 is located on the base 1 and connected to the base 1. The worm 30 is horizontally located inside the adjusting box 9 and two ends of the worm 30 pass through the adjusting box 9 and connect with the foot pedal assembly. The foot pedal assembly is configured to drive the worm 30 to rotate by riding motion with exercise's feet thereon. A second transmission assembly is located between the worm 30 and the first rotation shaft 25, and the second transmission assembly is configured to rotate the first rotation shaft 25 through the worm 30.

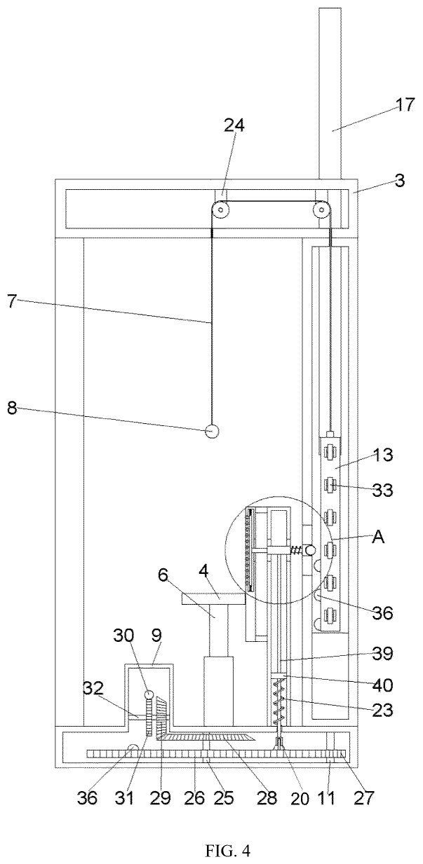

As illustrated in FIGS. 4 and 5, the second transmission assembly includes: a second rotation shaft 32, a worm wheel 31, a first bevel gear 28 and a second bevel gear 29. The second rotation shaft 32 is horizontally located under the worm 30 and perpendicular to the worm 30. Two ends of the second rotation shaft 32 are rotatably connected with the inner walls of the adjusting box 9 respectively. The worm wheel 31 is sleeved on the second rotation shaft 32. The worm 30 is meshed with the worm wheel 31. The first bevel gear 28 is sleeved near the second rotation shaft 32 on the first rotation shaft 25, and the second bevel gear 29 is sleeved near the first bevel gear 28 on the second rotation shaft 32. The second bevel gear 29 is meshed with the first bevel gear 28.

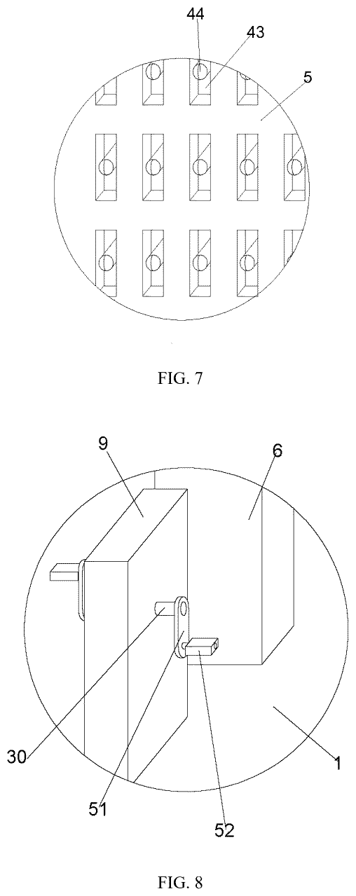

As illustrated in FIGS. 1, 4, 6 and 7, a sitting board 4 is horizontally located between the adjusting box 9 and the exercise box 2. A back board 5 is vertically arranged on a side close to the exercise box 2 of the sitting board 4, and the back board 5 has a hollow structure. A massage board 38 is vertically located in the back board 5, and an edge of the massage board 38 is connected to an inner wall of the back board 5 by a second resilient reset assembly. The second resilient reset assembly is configured to reset the massage board 38 quickly after moving vertically or horizontally. A side close to the adjusting box 9 of the back board 5 defines multiple massage grooves 43 vertically and evenly which are connected to the interior of the back board 5, and a massage rod 44 is horizontally arranged in each massage groove 43. An end of each massage rod 44 is connected to the massage board 38, and the other end of each massage rod 44 is located outside the back board 5. The other end of each massage rod 44 is a circular arc structure, facilitating the contact between the other end of each massage rods 44 and the back of the exerciser. A first massage assembly is located between the massage board 38 and the first spur gear 26, and the first massage assembly is configured to drive the massage board 38 to move up and down through the rotation of the first spur gear 26.

In an embodiment, a side near the adjusting box 9 of the back board 5 and the massage board 38 are both arc-shaped surfaces, facilitating the adaptation to the curvature of the back of the exerciser. Each massage rod 44 has the same length, allowing multiple massage rods 44 to form arc-shaped surfaces after passing through corresponding massage grooves 43, facilitating the adaptation to the curvature of the back of the exerciser and to massage the back of the exerciser.

As illustrated in FIGS. 4, 5, and 8, the first massage assembly includes: a massage box 37, a carrier rod 39, a first roller 20, multiple first hemispherical protrusions 35 and a moving rod 42. The massage box 37 is vertically located between the back board 5 and the exercise box 2. The carrier rod 39 is vertically located in the massage box 37 and the lower part of the carrier rod 39 passes through the massage box 37 and an upper part of the base 1 and is located in the interior of the base 1. The first roller 20 is located on the lower part of the carrier rod 39, and is in contact with an upper surface of the first spur gear 26. The multiple first hemispherical protrusions 35 are located on the upper surface of the first spur gear 26 and evenly arranged around the first rotation shaft 25. The multiple first hemispherical protrusions 35 are sequentially in contact with the first roller 20 during the rotation of the first spur gear 26, facilitating continually lifting the carrier rod 39 through the first roller 20. A third resilient reset assembly is provided between the carrier rod 39 and the massage box 37, and the third resilient reset assembly is configured to reset the carrier rod 39 quickly after moving upwards, making the first roller 20 be consistently in contact with the surface of the upper part of the first spur gear 26. The moving rod 42 is horizontally located at an upper part of the carrier rod 39. Two sides of the massage box 37 near the two ends of the moving rod 42 respectively define two first sliding grooves 45 vertically, and the back board 5 near the first sliding grooves 45 define a second sliding groove 46 vertically. An end of the moving rod 42 passes through one of the first sliding grooves 45 and the second sliding groove 46, and is connected with the massage board 38.

As illustrated in FIG. 1 and FIG. 4, an electric telescopic rod 6 is vertically disposed between the sitting board 4 and the base 1. Two ends of the electric telescopic rod 6 are respectively connected to the sitting board 4 and the base 1. The rear end of the sitting board 4 is slidably connected with the back board 5, facilitating the adjustment the height of sitting board 4 through the electric telescopic rod 6. Two fixing rods are horizontally located between the back board 5 and the massage box 37, and the two fixing rods are located above and below the moving rod 42 respectively. Two ends of the moving rod 42 are connected with the back board 5 and the massage box 37 respectively.

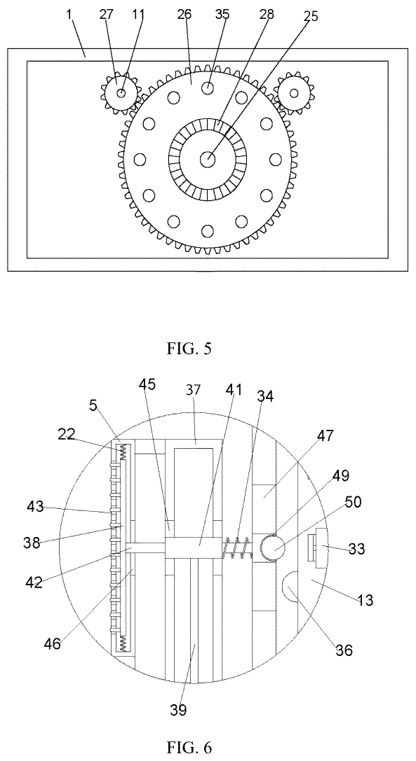

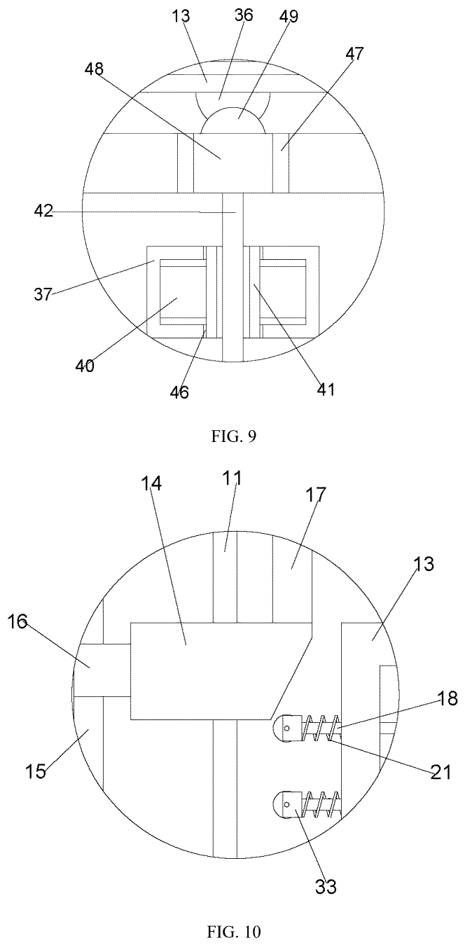

As illustrated in FIGS. 6 and 9, a sleeve 41 is sleeved on the moving rod 42 and two ends of the sleeve 41 are respectively located in the two first sliding grooves 45. The sleeve 41 is a square prism, and outer side surfaces of the sleeve 41 are in contact with the inner walls of the two first sliding grooves 45, facilitating sliding up and down the sleeve 41 along the two first sliding grooves 45. An upper end of the carrier rod 39 is connected to the sleeve 41. The exercise box 2 defines a third sliding groove 47 vertically near the other first sliding groove 45, and the third sliding groove 47 is connected to the exercise box 2 and a slider 48 is located in the third sliding groove 47. The other end of the moving rod 42 passes through the other first sliding groove 45 and is connected with the slider 48. A second massage assembly is located between the slider 48 and the adjusting sleeve 13. The second massage assembly is configured to drive the massage board 38 to move horizontally back and forth by the moving rod 42 and the massage board 38 drives multiple massage rods 44 to move horizontally, so as to massage the back of the exerciser percussively in the process of upper limb strength exercise.

As illustrated in FIGS. 6 and 9, the second massage assembly includes: multiple second hemispherical protrusions 36 located on a side close to the slider 48 of the adjusting sleeve 13. The multiple second hemispherical protrusions 36 are located under the slider 48 and arranged evenly and vertically. A spherical surface of each second hemispherical protrusion 36 faces towards the slider 48. The slider 48 defines a ball groove 49 on a side near the adjusting sleeve 13, and a movement ball 50 is located in the ball groove 49. The movement ball 50 rotates freely in the ball groove 49, and a side of the movement ball 50 is close to the adjusting sleeve 13. A traction assembly is located above the sitting board 4, and the traction assembly is connected to the adjusting sleeve 13. The traction assembly is configured to drive the adjusting sleeve 13 to move up and down for upper limb strength exercise.

As illustrated in FIGS. 1 and 4, the traction assembly includes: a roof panel 3, a cross bar 8 and a drawstring 7. The roof panel 3 is horizontally located on the exercise box 2, an upper part of the exercise box 2 is connected to a rear part of the roof panel 3. Two sides of a lower part of the roof panel 3 near a front part of the roof panel 3 are connected with the base 1 through vertically arranged support columns 10 respectively. The roof panel 3 has a hollow structure. An upper end of each guide board 17 passes through the exercise box 2 and the roof panel 3 and is slidably connected with the exercise box 2 and the roof panel 3. The cross bar 8 is horizontally located between the sitting board 4 and the roof panel 3. The drawstring 7 is located in the roof panel 3, and two ends of the drawstring 7 are respectively connected to the cross bar 8 and the adjusting sleeve 13. Two fixed pulleys 24 are respectively located at a position close to the sitting board 4 in the roof panel 3 and a position close to the exercise box 2 in the roof panel 3. The drawstring 7 passes through the two fixed pulleys 24, facilitating the moving of the drawstring 7.

As illustrated in FIG. 8, the foot pedal assembly includes: two foot pedals 52, the two foot pedals 52 are horizontally located on two sides of the adjusting box 9. The two foot pedals 52 are located above and below the worm 30 respectively, and the foot pedals 52 are rotatably connected with each other by vertically disposed connecting rods 51. The exerciser steps on the two foot pedals 52 with two feet for cycling, driving the worm 30 to rotate forward and reverse. At the same time, the exerciser can continuously step on the two foot pedals 52 to drive the worm 30 forward and backward before exercising upper limb strength, and engage in aerobic exercise through cycling. In this way, the exerciser can warm up with aerobic exercise before anaerobic exercise, and after the warm-up is completed, the exerciser can adjust the exercise load to the minimum or appropriate value for upper limb strength exercise.

As illustrated in FIGS. 2 and 10, each first resilient reset assembly includes: a second roller 33, the second roller 33 is located on the other end of the respective positioning rod 18, and the second roller 33 facilitates reducing the friction between the positioning rod 18 and the guide block 14. A first elastic member 21 is located between the second roller 33 and the adjusting sleeve 13 and located on each positioning rod 18. Two ends of each first elastic member 21 are respectively connected with the corresponding second roller 33 and the adjusting sleeve 13. The first elastic assemblies 21 facilitate the reset of the positioning rods 18 after moving horizontally.

As illustrated in FIG. 6, the second resilient reset assembly includes: four second elastic members 22 vertically disposed on four corners of the massage board 38 respectively. Two ends of each second elastic member 22 are respectively connected with the edge of the massage board 38 and the inner wall of the back board 5. The four second elastic members 22 facilitate the reset of the massage board 38 after moving vertically.

As illustrated in FIG. 4, the third resilient reset assembly includes: a moving block 40. The moving block 40 is located in the massage box 37 and is slidably connected with the inner wall of the massage box 37. The carrier rod 39 passes through the moving block 40 and is fixedly connected with the moving block 40. Under the moving block 40, a third elastic member 23 is sleeved on the carrier rod 39. Two ends of the third elastic member 23 are connected with the moving block 40 and the bottom of the massage box 37, facilitating the reset of the carrier rod 39 after moving upwards.

As illustrated in FIG. 6, a fourth elastic member 34 is sleeved between the slider 48 and the sleeve 41 and on the moving rod 42. Two sides of the fourth elastic member 34 are connected with the slider 48 and the sleeve 41 respectively, facilitating the fast reset of the slider 48 after moving horizontally. Meanwhile, the multiple second hemispherical protrusions 36 drive the slider 48 to move horizontally within the third sliding groove 47 with a distance smaller than the width of the third sliding groove 47, preventing the slider 48 from sliding out of the third sliding groove 47.

The auxiliary exercise device based on sports kinesiology of the present disclosure further includes: a laser ranging sensor located at a top of the exercise box 2. The laser ranging sensor is configured to monitor the moving distance of the two guide blocks 14. By monitoring the moving distance of the two guide blocks, the adjusting number of the weights 12 can be ensured to further ensure the exercise load. A display screen is located on an upper part of the adjusting box 9. The display screen is electrically connected with the laser ranging sensor, and a calculating module is provided in the display screen. The laser ranging sensor is able to transmit the monitored distance of the two guide blocks 14 in real-time to the display screen. The calculating module in the display screen calculates the motion load value based on the moving distance of the two guide blocks 14 and displays it on the display screen, making it easy to visually see the size of the load value.

Working principle of the auxiliary exercise device is as follows: when in use, the exerciser sits on the sitting board 4, the back of exercise abuts against the back board 5, so that multiple massage rods 44 are in contact with the exerciser's back. Then, the height of the sitting board 4 is adjusted by the electric telescopic rod 6 to adapt to the height of the exerciser. Then, the exerciser's feet are respectively stepped on the two foot pedals 52. Initially, the two guide blocks 14 are located at the top of the adjusting sleeve 13 and the topmost two positioning rods 18 are not inserted into the corresponding positioning holes 19, making the exercise load at the minimum value. Then, the feet exert force to ride, driving the worm 30 and the worm wheel 31 to rotate forward. The worm wheel 31 drives the second rotation shaft 32 to rotate. The second rotation shaft 32 drives the first bevel gear 28 to rotate through the second bevel gear 29, and the first bevel gear 28 drives the first spur gear 26 to rotate through the first rotation shaft 25. The first spur gear 26 drives the two second spur gears 27 to rotate synchronously, and the two second spur gears 27 drive the two lead screws 11 to rotate synchronously forward. The two lead screws 11 drive the two guide blocks 14 to move downwards, and the two guide blocks 14 drive the two guide boards 17 to move downwards.

When the inclined surfaces of the two guide blocks 14 are in contact with the two topmost second rollers 33, the two positioning rods 18 are driven to move towards the adjusting sleeve 13 by the two topmost second rollers 33, the ends of the two topmost positioning rods are inserted into the corresponding positioning holes 19. The two topmost second rollers 33 finally move to the two guide boards 17, making the two positioning rods 18 be completely inserted into the corresponding positioning holes 19. Meanwhile, the adjusting sleeve 13 is connected to the topmost weight 12. Then, the exerciser stops walking, holds the cross bar 8 with two hands, and pulls the cross bar 8 downwards. The cross bar 8 drives the adjusting sleeve 13 and the topmost weight 12 to move upwards for upper limb strength exercise through the drawstring 7. While the adjusting sleeve 13 moves upwards, the two topmost second rollers 33 are driven to move along the two guide boards 17.

When it is necessary to further increase the exercise load, it is only necessary to repeat the above steps and continue cycling to make the worm 30 rotate forward. The exercise load is gradually increased during the exercise process, so that the exercise can be gradually improved. When it is necessary to reduce the exercise load, it is only necessary to rotate the worm 30 in the opposite direction and drive the two guide blocks 14 to move upwards.

When the first spur gear 26 rotates, it drives the multiple first hemispherical protrusions 35 to rotate. The multiple first hemispherical protrusions 35 pass through the first roller 20 in sequence, continuously pushing the carrier rod 39 up and down through the first roller 20. Under the action of the third resilient reset assembly, the carrier rod 39 drives the moving rod 42 to move up and down, and the moving rod 42 drives the massage board 38 to move up and down. The massage board 38 drives the multiple massage rods 44 to move up and down in the corresponding massage grooves 43, thereby adjusting the exercise load and pushing the back of the exerciser for massage and promoting blood circulation in the back of the exerciser.

When the adjusting sleeve 13 moves up and down, it drives the multiple second hemispherical protrusions 36 to move up and down, thereby making the multiple second hemispherical protrusions 36 pass through the movement ball 50 in sequence, the movement ball 50 is continuously pushed towards the massage box 37 and resets under the action of the second resilient reset assembly, the moving rod 42 is driven to drive the massage plate 38 to move back and forth horizontally, the massage board 38 drives the multiple massage rods 44 to move horizontally, thereby tapping and massaging the back of the exerciser during upper limb strength exercise, further promoting blood circulation in the exerciser's back.

What is claimed is:

1. A auxiliary exercise device based on sports kinesiology, comprising:
an exercise box (2);
a plurality of weights (12), vertically located in the exercise box (2);
an adjusting sleeve (13), sleeved on the plurality of weights (12); wherein two sides of each weight (12) respectively define two positioning holes (19);
a plurality of groups of positioning rods (18), corresponding to the plurality of weights (12), respectively; wherein each group of positioning rods (18) comprises two positioning rods (18) horizontally located at the two sides of the respective weight (12); an end of each positioning rod (18) passes through an inner wall of the adjusting sleeve (13) and is connected to a first resilient reset assembly, and another end of each positioning rod (18) is close to a corresponding one of the two positioning holes (19) of the respective weight (12);
two guide blocks (14), located at two sides of the adjusting sleeve (13) respectively; wherein the two guide blocks (14) are close to the plurality of groups of positioning rods (18), and two opposite surfaces of the two guide blocks (14) are inclined surfaces and are in a splayed shape;
two guide boards (17), vertically located on upper parts of the two guide blocks (14), respectively;
an up-and-down moving assembly, located in the exercise box (2) and connected to the two guide blocks (14); wherein the up-and-down moving assembly is configured to drive the two guide blocks (14) to move downward, thereby to make the inclined surfaces of the two guide blocks (14) sequentially drive the plurality of group of positioning rods (18) to be inserted into the positioning holes (19) of the plurality of weights (12), or drive the two guide blocks (14) to move upward, thereby to make the inclined surfaces of the two guide blocks (14) sequentially drive the plurality of group of positioning rods (18) to be withdrawn from the positioning holes (19) of the plurality of weights (12); and
a foot pedal assembly, located outside the exercise box (2); wherein the foot pedal assembly is configured to provide power for the up-and-down moving assembly.

2. The auxiliary exercise device based on sports kinesiology as claimed in claim 1, wherein the up-and-down moving assembly comprises: two lead screws (11) vertically located at two sides of the adjusting sleeve (13) respectively and closed to the two guide blocks (14) respectively; each lead screw (11) passes through the respective guide block (14) and is threadedly connected to the respective guide block (14); two ends of each lead screw (11) are rotatably connected to inner walls of the exercise box (2) respectively; a side of each guide block (14) facing away from the adjusting sleeve (13) is slidably connected to an inner wall of the exercise box (2) in a vertical direction, and the two lead screws (11) are connected to a first transmission assembly.

3. The auxiliary exercise device based on sports kinesiology as claimed in claim 2, wherein the first transmission assembly comprises: a base (1), a first rotation shaft (25), a first spur gear (26), two second spur gears (27), an adjusting box (9) and a worm (30); the base (1) is located on a bottom of the exercise box (2) and the base (1) has a hollow structure; a lower end of each lead screw (11) passes through the exercise box (2) and an upper part of the base (1), and is rotatably connected with a lower part of the base (1); the first rotation shaft (25) is vertically located between the two lead screws (11), and the first spur gear (26) is sleeved on the first rotation shaft (25); the two second spur gears (27) are respectively sleeved on the two lead screws (11), and the first spur gear (26) is meshed with each of the two second spur gears (27);
the adjusting box (9) is located on the base (1) and connected to the base (1); the worm (30) is horizontally located in the adjusting box (9), and two ends of the worm (30) pass through the adjusting box (9) and are connected with the foot pedal assembly; the foot pedal assembly is configured to drive the worm (30) to rotate; and a second transmission assembly is provided between the worm (30) and the first rotation shaft (25).

4. The auxiliary exercise device based on sports kinesiology as claimed in claim 3, wherein the second transmission assembly comprises: a second rotation shaft (32), a worm wheel (31), a first bevel gear (28) and a second bevel gear (29); the second rotation shaft (32) is horizontally located under the worm (30) and perpendicular to the worm (30); the worm wheel (31) is sleeved on the second rotation shaft (32); the worm (30) is meshed with the worm wheel (31); the first bevel gear (28) is sleeved near the second rotation shaft (32) on the first rotation shaft (25), and the second bevel gear (29) is sleeved near the first bevel gear (28) on the second rotation shaft (32), and the second bevel gear (29) is meshed with the first bevel gear (28).

5. The auxiliary exercise device based on sports kinesiology as claimed in claim 4, wherein a sitting board (4) is horizontally located between the adjusting box (9) and the exercise box (2); a back board (5) is vertically located on a side close to the exercise box (2) of the sitting board (4), and the back board (5) has a hollow structure; a massage board (38) is vertically located in the back board (5), and an edge of the massage board (38) is connected to an inner wall of the back board (5) by a second resilient reset assembly; a side close to the adjusting box (9) of the back board (5) defines a plurality of massage grooves (43) vertically and evenly, and a massage rod (44) Is horizontally located in each massage groove (43); an end of each massage rod (44) is connected to the massage board (38); a first massage assembly is located between the massage board (38) and the first spur gear (26), and the first massage assembly is configured to drive the massage board (38) to move up and down through rotation of the first spur gear (26).

6. The auxiliary exercise device based on sports kinesiology as claimed in claim 5, wherein the first massage assembly comprises: a massage box (37), a carrier rod (39), a first roller (20), a plurality of first hemispherical protrusions (35) and a moving rod (42); the massage box (37) is vertically located between the back board (5) and the exercise box (2); the carrier rod (39) is vertically located in the massage box (37), and a lower part of the carrier rod (39) passes through the massage box (37) and an upper part of the base (1) and is located in the base (1); the first roller (20) is located on the lower part of the carrier rod (39), and the first roller (20) is in contact with an upper surface of the first spur gear (26); the plurality of first hemispherical protrusions (35) are located on the upper surface of the first spur gear (26) and evenly arranged around the first rotation shaft (25); the plurality of first hemispherical protrusions (35) are sequentially in contact with the first roller (20) during the rotation of the first spur gear (26); a third resilient reset assembly is provided between the carrier rod (39) and the massage box (37); the moving rod (42) is horizontally located at an upper part of the carrier rod (39); two sides of the massage box (37) near two ends of the moving rod (42) respectively define two first sliding grooves (45) vertically, and the back board (5) defines a second sliding groove (46) vertically near the first sliding grooves (45); an end of the moving rod (42) passes through one of the first sliding grooves (45) and the second sliding groove (46) and is connected with the massage board (38).

7. The auxiliary exercise device based on sports kinesiology as claimed in claim 6, wherein a sleeve (41) is sleeved on the moving rod (42) and two ends of the sleeve (41) are respectively located in the two first sliding grooves (45); the upper part of the carrier rod (39) is connected to the sleeve (41); the exercise box (2) defines a third sliding groove (47) vertically near the other first sliding groove (45), and a slider (48) is located in the third sliding groove (47); the other end of the moving rod (42) passes through the other first sliding groove (45) and is connected with the slider (48); a second massage assembly is located between the slider (48) and the adjusting sleeve (13), and the second massage assembly is configured to drive the massage board (38) to move horizontally back and forth by the moving rod (42).

8. The auxiliary exercise device based on sports kinesiology as claimed in claim 7, wherein the second massage assembly comprises: a plurality of second hemispherical protrusions (36) located on a side close to the slider (48) of the adjusting sleeve (13); the plurality of the second hemispherical protrusions (36) are located under the slider (48) and arranged evenly and vertically; a side near the adjusting sleeve (13) of the slider (48) defines a ball groove (49) and a movement ball (50) is located in the ball groove (49); a side of the movement ball (50) is close to the adjusting sleeve (13); a traction assembly is provided above the sitting board (4) and the traction assembly is connected to the adjusting sleeve (13).

9. The auxiliary exercise device based on sports kinesiology as claimed in claim 8, wherein the traction assembly comprises: a roof panel (3), a cross bar (8) and a drawstring (7); the roof panel (3) is horizontally located on the exercise box (2), an upper part of the exercise box (2) is connected to a rear part of the roof panel (3); two sides of a lower part of the roof panel (3) near a front part of the roof panel (3) are connected with the base (1) through vertically arranged support columns (10); the roof panel (3) has a hollow structure; an upper end of each guide board (17) passes through the exercise box (2) and the roof panel (3), and is slidably connected with the exercise box (2) and the roof panel (3); the cross bar (8) is horizontally located between the sitting board (4) and the roof panel (3); the drawstring (7) is located in the roof panel (3), and two ends of the drawstring (7) are respectively connected to the cross bar (8) and the adjusting sleeve (13).

10. The auxiliary exercise device based on sports kinesiology as claimed in claim 9, wherein the foot pedal assembly comprises: two foot pedals (52), the two foot pedals (52) are horizontally located at two sides of the adjusting box (9); the two foot pedals (52) are located above and below the worm (30) respectively, and each foot pedal (52) is rotatably connected with the worm (30) by a vertically arranged connecting rod (51).
